(19) United States
(12) Patent Application Publication
(10) Pub. No.: US 2005/0095473 A1
(43) Pub. Date: May 5, 2005

(54) Water supply device for fuel cell

(76) Inventors: Akihiro Sakakida, Yokosuka-shi (JP); Tsutomu Yamazaki, Yokosuka-shi (JP); Akihiro Asai, Yokosuka-shi (JP)

Correspondence Address: MCDERMOTT WILL & EMERY LLP, 600 13th Street, N.W., Washington, DC, 20005-3096, US

(21) Appl. No.: 10/958,651

(22) Filed: Oct. 6, 2004

(30) Foreign Application Priority Data
Oct. 6, 2003 (JP) 2003-347073

(51) Int. Cl. H01M 8/18; H01M 8/00; H01M 8/04; H01M 8/12; H01M 8/10

(52) U.S. Cl. 429/20; 429/22; 429/26; 429/25; 429/32; 429/13

(57) ABSTRACT

A water supply device, which performs humidification and/or cooling of a fuel cell stack (2), is disclosed. The water supply device includes a water tank (25) for storing water, and a pump which sends water from the water tank (5) to the fuel cell stack (2), wherein one of a discharge port (39) and intake port (37) of the pump (26) is situated in the bottom portion of a pump chamber. The water supply device further includes a recirculation passage (28) which recirculates water between the water tank (25) and the fuel cell stack (2), and a compressor (20) which functions to supply water stored in the water tank to the pump by supplying air to the water tank. A controller (6) of the water supply device programmed to: command the compressor (20) to supply air to the water tank, when the fuel cell stack (2) is to be started up, and subsequently command the pump to start.

### FIELD OF THE INVENTION

This invention relates to a water supply device which supplies water to a fuel cell for the purpose of humidification and/or cooling. In particular, the water supply device aspirates water collected in a water storage tank and supplies this water to the fuel cell.

### BACKGROUND OF THE INVENTION

A water supply device disclosed in Tokkai 2002-81393, published by the Japan Patent Office in 2002, collects the water in the pump and passage in a water storage tank after the operation of the pump has finished. This prevents water remaining in the interior of a pump and passage from freezing.

The pump of this water supply device of the prior art is a self-aspiration type pump and has an intake port situated coaxially with the rotation axis of a pump impeller which rotates in a horizontal plane and below the impeller. To aspirate the fluid in the pump, the water intake passage does not have a check valve and is always open. Consequently, after the pump has stopped operating, most of the water in the pump returns to the water storage tank.

### SUMMARY OF THE INVENTION

The water supply device generates an intake negative pressure of the pump by supplying water to the pump in advance. Therefore, when the pump starts, the pump impeller must be immersed in water. In a water supply device installed in a vehicle, if the vehicle inclines at an angle, the pump impeller cannot entirely be immersed in water. Therefore, the pump may not generate an effective intake negative pressure and may not start correctly.

It is therefore an object of this invention to provide a water supply device for a fuel cell which can be applied to a vehicle which inclines according to a road surface.

In order to achieve the above object, this invention provides a water supply device which performs humidification and/or cooling of a fuel cell stack. The water supply device comprises a water tank for storing water; a pump which sends water from the water tank to the fuel cell stack, wherein one of a discharge port and intake port of the pump is situated in the bottom portion of a pump chamber; a recirculation passage which recirculates water between the water tank and the fuel cell stack, wherein water leaves the water tank and flows through the pump and fuel cell stack to return to the water tank; a compressor which functions to supply water stored in the water tank to the pump by supplying air to the water tank; and a controller. The controller is programmed to command the compressor to supply air to the water tank so as to start an operation of the water supply device, and subsequently command the pump to start.

This invention further provides a start method for starting the water supply device. The start method comprises commanding the compressor to supply air to the water tank whereby water stored in the water tank is supplied to the pump, and subsequently commanding the pump to start.

The details as well as other features and advantages of this invention are set forth in the remainder of the specification and are shown in the accompanying drawings.

### BRIEF DESCRIPTION OF THE DRAWINGS

FIG. 1 is a schematic view of a water supply device which supplies water to a fuel cell according to a first embodiment.

FIG. 2 is a schematic cross-sectional view of a fuel cell stack.

FIG. 3A is a schematic plan view of a water supply pump, and FIG. 3B is a schematic side view of the water supply pump.

FIG. 4 is a flowchart showing a control routine of the water supply device performed by a controller.

FIG. 5 is a map showing a purged air amount relative to a fluid momentum (differential pressure) and an air purging time. The curve A is an isovalue curve for the purged air amount.

### DESCRIPTION OF THE PREFERRED EMBODIMENTS

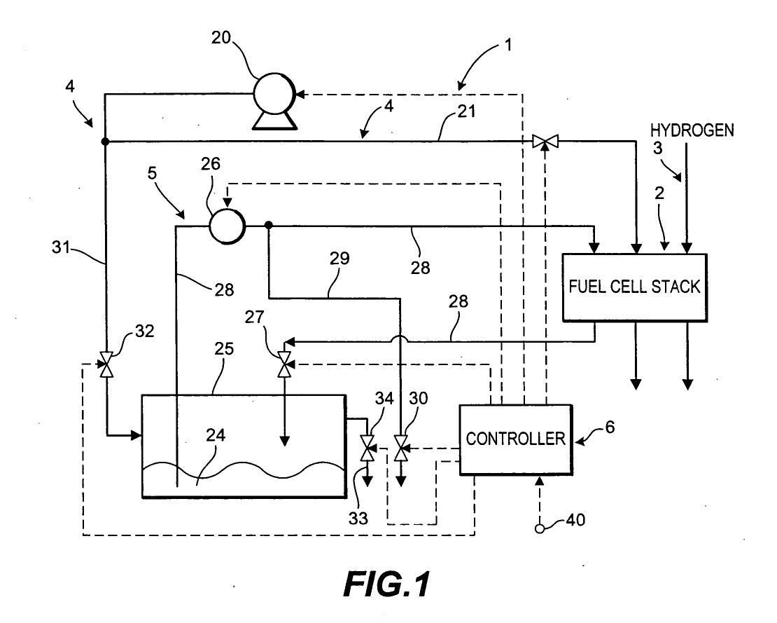

Referring to FIG. 1, a fuel cell system 1 comprises a fuel cell stack 2, hydrogen supply line 3 which supplies hydrogen gas as fuel to the fuel cell stack 2, air supply line 4 which supplies air (oxygen) as an oxidizing agent to the fuel cell stack 2, and a water supply line 5 which supplies cooling water to cool and/or humidify the fuel cell stack 2. Power generation by the fuel cell stack 2, transport of hydrogen gas in the hydrogen supply line 3, transport of the air in the air supply line 4 and transport of water in the water supply line are controlled by a controller 6.

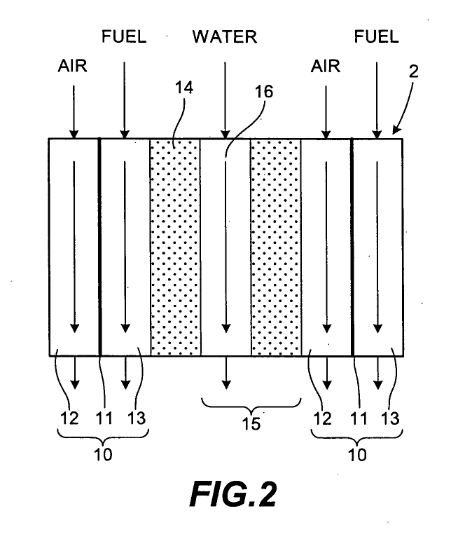

Referring to FIG. 2, the fuel cell stack 2 comprises a membrane electrode assembly 11 comprising a polymer electrolyte membrane, and a fuel electrode and oxygen electrode disposed on both sides of the polymer electrolyte membrane. The fuel cell stack 2 further comprises an oxygen electrode side collection plate 12 which forms a fluid passage for supplying air to the membrane electrode assembly 11 behind the oxygen electrode, and a fuel electrode side collection plate 13 which forms a fluid passage for supplying hydrogen to the membrane electrode assembly 11 behind the fuel electrode. The collection plates 12, 13 are formed from porous bodies. The membrane electrode assembly 11 and collection plates 12, 13 form an individual cell 10. A cooling plate 15 which forms a cooling water passage 16 is disposed behind the fuel electrode side collection plate 13 via a humidifying water permeating plate 14 formed from a porous body. Humidifying water permeates into the permeating plate 14. The fuel cell stack 2 is formed by laminating plural sets of the cells 10, the humidifying water permeating plates 14 and the cooling plates 15.

Hydrogen from the hydrogen supply line 3 is supplied to the fuel electrode. Air from the air supply line 4 is supplied to the oxygen electrode. Due to the reaction between hydrogen and oxygen, the fuel cell generates power. Cooling water supplied from the water supply line 5 to the interior of the cooling plate 15 removes heat produced during power generation. Part of the cooling water supplied to the cooling plate 15 wets the humidifying water permeating plate 14 and fuel electrode side collection plate 13, and is supplied to the fuel electrode. Hence, the polymer electrolyte membrane is humidified, and part of the cooling water evaporates in the hydrogen gas and air. At this time, the latent vaporization heat removes part of the reaction heat of the cell. Part of the cooling water passes through the cooling plate 15 to reach the oxygen electrode side collection plate 12 on the rear side, and removes part of the reaction heat of the cell by sensible heat. The remaining cooling water is discharged from the fuel cell stack 2.

By adjusting the pressure of the cooling water and thus by varying the differential pressure between the fuel gas and cooling water, the water amount supplied to the fuel electrode side as humidifying water can be adjusted. When the pressure of the cooling water is increased (i.e., the differential pressure is decreased), the water amount supplied as humidifying water increases. When the pressure of the cooling water is decreased (i.e., the differential pressure is increased), the water amount supplied as humidifying water can be reduced. Also, by adjusting the cooling water flowrate, the reaction heat of the cell removed by sensible heat can be adjusted.

Referring again to FIG. 1, the air supply line 4 comprises a pipe 21 and a compressor 20, and air compressed by the compressor 20 is sent to the fuel cell stack 2 via the pipe 21.

The water supply line 5 comprises a cooling water tank 25, pump 26, pressure control valve 27 and a heat exchanger, not shown, which are connected in series on a recirculation passage 28. The cooling water tank 25 stores cooling water 24. The recirculation passage 28 is connected to the cooling water passage 16 of the cooling plate 15. The pump 26 supplies the cooling water 24 stored in the cooling water tank 25 to the cooling plate 15 of the fuel cell stack 2. The cooling water returns from the cooling plate 15 of the fuel cell stack 2 to the cooling water tank 25 via the back pressure control valve 27 and heat exchanger. The open end on the discharge side of the recirculation passage 28 is situated inside the cooling water tank 25. The controller 6 controls the rotation speed of the pump 26 by transmitting a rotation speed command value to the pump 26 and the pressure of the recirculation passage 28 by transmitting a pressure command value to the back pressure control valve 27. A passage 29 branches off from the recirculation passage 28 immediately downstream of the pump 26, and leads to the atmosphere. A shutoff valve 30 which is normally closed, but opened by the controller when the pump 26 starts, is disposed in the discharge passage 29.

An air inlet passage 31 which branches off from the pipe 21 of the air supply line 4, is connected to the cooling water tank 25. A shutoff valve 32 which is normally closed, whereof the opening and closing is controlled by the controller 6, is disposed in the air inlet passage 31. A shutoff valve 34 which is normally open, whereof the opening and closing is controlled by the controller 6, is disposed in an atmosphere opening passage 33 which opens to the outside air at its end. When the shutoff valve 32 is opened after the compressor 20 of the air supply line 4 has been operated, compressed air is led into the cooling water tank 25 via the air inlet passage 31. If the back pressure control valve 27 and shutoff valve 34 of the atmosphere opening passage 33 are closed during introduction of compressed air, the cooling water tank 25 is pressurized. When the cooling water tank 45 is pressurized, the stored cooling water 24 is pressurized by the compressed air, so that the cooling water flows out to the pump 26 via the recirculation passage 28.

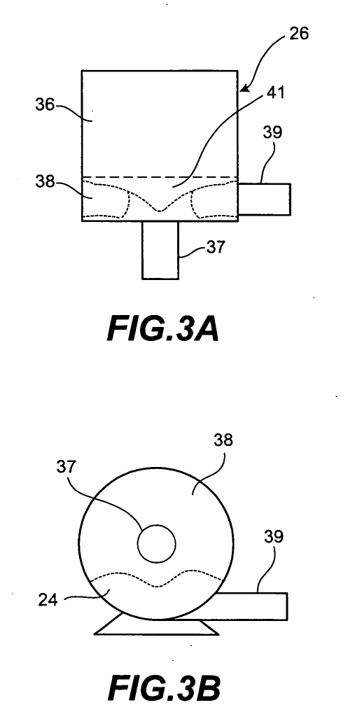

Referring to FIG. 3, the pump 26 is a volute pump wherein an impeller 41 of the pump 26 is rotated by a drive motor 36 installed horizontally with its drive axis being horizontal. The impeller 41 is a rotating member which, by its rotation, forces fluid towards the outside of the radial direction relative to the rotation axis. An intake port 37 is situated in the middle part of a substantially cylindrical pump chamber (or impeller chamber) 38 in which the impeller is housed and rotates, and an air discharge port 39 is situated in the bottom portion of the pump chamber 38. The recirculation passage 28 extends from the bottom portion of the pump chamber 38. As a result, when the pump 26 has stopped, water present in the pump chamber 38 flows out from the discharge port 39 which opens out at a lower position in the pump chamber 38 which has a substantially cylindrical shape, and does not remain in the pump chamber 38.

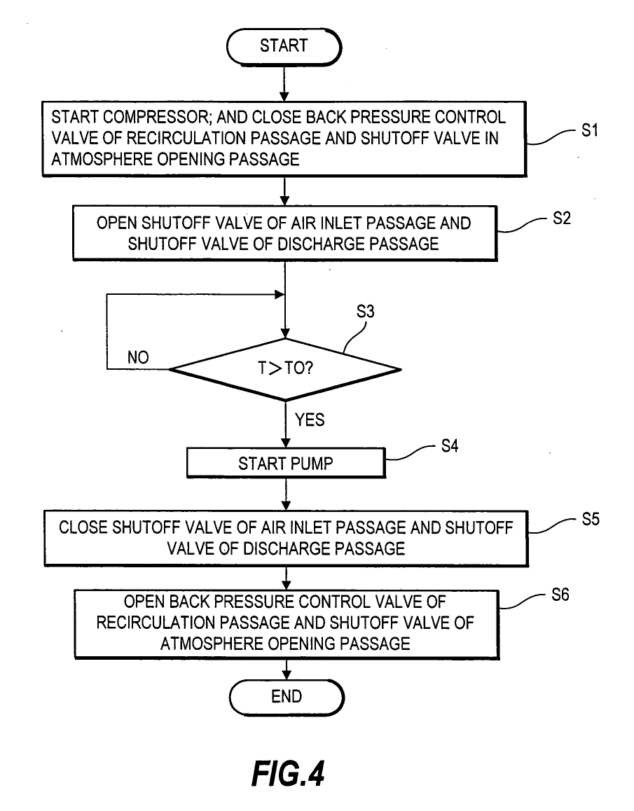

Referring to the flowchart of FIG. 4, the control routine of the water supply device performed by the controller 6 will now be described. The controller 8 comprises a microcomputer having a central processing unit (CPU), read-only memory (ROM), random access memory (RAM) and input/output interface (I/O) interface.

A startup switch 40 of the fuel cell system is switched ON/OFF by an operator, and is electrically connected to the controller 8 to send an ON/OFF signal to the controller 8. When the startup switch 40 is switched OFF, the controller 8 performs control to stop the fuel cell system 1 in response to the OFF signal. When the fuel cell system 1 has stopped, the controller 8 performs control to stop the pump 26 and compressor 20, and open the back pressure control valve 27. The positions of the pump 26 and fuel cell stack 2 are higher than the position of the cooling water tank. Therefore, the cooling water in the fuel cell stack 2 returns to the cooling water tank 25 via the open back pressure control valve 27. In this way, damage to the pump 26 due to freezing of water at low temperature can be prevented.

If the position of the pump 26 is higher than the position of the fuel cell stack 2, cooling water in the pump chamber 38 and cooling water in the recirculation passage 28 between the pump 26 and cooling water tank 25 returns to the cooling water tank 25 via the cooling water passage 16 of the fuel cell stack 2. If the position of the pump 26 is lower than the position of the fuel cell stack 2, the shutoff valve 30 in the discharge passage 29 is opened to permit efficient discharge of cooling water in the lower part of the pump chamber and in the recirculation passage 28 between the fuel cell stack 2 and pump 26. In this way, when the fuel cell system 1 has stopped, no water remains in the pump 26 and fuel cell stack 2. Subsequently, the shutoff valve 30 in the discharge passage 29 is closed, the shutoff valve 34 in the atmosphere opening passage 33 remains open, and the shutoff valve 32 in the air inlet passage 31 remains closed.

If the intake port 37 of the pump 26 is situated in the bottom portion of the pump chamber 38, all the cooling water in the recirculation passage 28 up to the fuel cell stack 2, including that in the pump chamber 38, can be made to flow back into the cooling water tank 25.

When the fuel cell stack is to be started up, the startup switch 40 is switched ON. When the startup switch 40 is switched ON, the controller 6 starts the operation of the water supply device according to the control routine shown in the flowchart of FIG. 4. The controller 6 executes the control routine as a program or programs.

First, in a step S1, the back pressure control valve 27 and shutoff valve 34 in the atmosphere opening passage 33 are closed, and the compressor 20 of the air supply line 4 is started. Due to the closure of the back pressure control valve 27 and shutoff valve 34, communication between the cooling water tank 25, the fuel cell stack 2 and the atmosphere is shut off. Compressed air from the compressor 20 is supplied to the fuel cell stack 2 via the pipe 21, and supplied to the passage of the oxygen electrode side collection plate 12.

In a step S2, the shutoff valve 32 of the air inlet passage 31 is opened, and the shutoff valve 30 of the discharge passage 29 is opened. Due to the opening of the shutoff valve 32, compressed air from the compressor 20 is introduced to the cooling water tank 25, and the pressure in the cooling water tank 25 rises. Due to the internal pressure, the liquid surface of the cooling water 24 falls, and the stored cooling water 24 flows into the pump 26 via the recirculation passage 28. Simultaneously, due to the opening of the shutoff valve 30 in the discharge passage 29, air which was left in the pump chamber 38 is discharged in a short time to the atmosphere (or outside air) via the discharge passage 29, and the pressure on the discharge side of the pump 26 falls. Due to the pressure difference between the cooling water tank 25 and discharge side of the pump 26, the cooling water 24 in the cooling water tank 25 flows into the pump 26 via the recirculation passage 28. In this case, the cooling water 24 is supplied to the pump chamber 38 regardless of whether the intake port 37 of the pump 26 is situated in the middle, upper part or lower part of the pump chamber 38, and regardless of the posture of the vehicle or the inclination of a road surface on which the vehicle is standing.

In a step S3, it is determined whether or not an elapsed time T after the step S2 was executed, has reached a predetermined time T0. The step S2 is repeated until the predetermined time T0 has elapsed. If the predetermined time T0 has elapsed, the routine proceeds to the step S4. The predetermined time T0 is a sufficient time for the cooling water 24 to fill the pump chamber 38 of the pump 26, and signifies a suitable air purging time (i.e., operating time of the compressor 20).

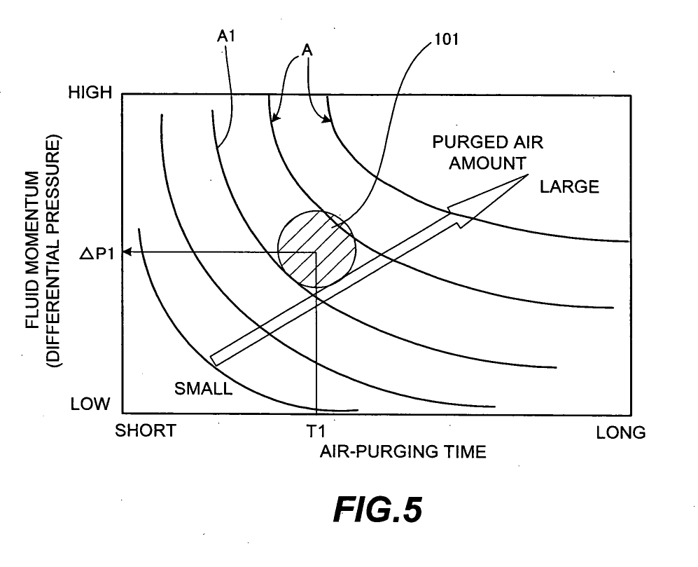

Referring to FIG. 5, the determination of the predetermined time T0 will be described in more detail. FIG. 5 shows a purged air amount relative to the fluid momentum (differential pressure) and air purging time. Herein, the differential pressure is the difference between the air pressure introduced to the cooling water tank 25 and the pressure of the discharge port of the pump (atmospheric pressure level). The purged air amount is approximately equivalent to the amount of cooling water sent from the cooling water tank 25 to the pump 26 and discharge passage 29. The fluid momentum increases with increase of the water supply pressure of the compressor 20. The air purging time is the time for cooling water to be sent from the cooling water tank 25 to the pump 26 and discharge passage 29 by the operation of the compressor 20 during this interval. As the fluid momentum and air purging time increase, the purged air amount increases. The predetermined time T0 (suitable air purging time) is determined such that the air amount to be purged is larger than the total volume of the recirculation passage 28 from the cooling water tank 25 to the pump 26 and the pump chamber 38. For example, if the total volume is A1, the differential pressure and predetermined time T0 are determined as ΔP1 and T1 in the shaded region 101 of the figure. The shaded region 101 is situated above the curve A1. However, the differential pressure and predetermined time T0 must be set so that the air amount to be purged does not exceed the stored water amount in the cooling water tank 25, and the air pressure introduced to the cooling water tank 25 does not exceed the maximum supply pressure of the compressor 20.

The map of FIG. 5 may be stored in a memory of the controller 6. The controller 6 may compute the differential pressure based on a pressure command value (or rotation speed command value) sent to the compressor 20, and may determine the predetermined time T0 by referring to a map based on the computed differential pressure and the total volume of the recirculation passage 28 from the cooling water tank 25 to the pump 26 and the pump chamber 38 measured beforehand by experiment.

In a step S4, the pump 26 is started. Next, in a step S5, the shutoff valve 32 of the air inlet passage 31 and the shutoff valve 30 of the discharge passage 29 are closed. Next, in a step S6, the back pressure control valve 27 of the recirculation passage 28 and shutoff valve 34 of the atmosphere opening passage 33 are opened. This completes the startup control of the pump 26.

In the step S3, cooling water is supplied during the predetermined time T0, so the pump chamber 38 of the pump 26 is filled with cooling water. In the step S4, the controller 6 starts the pump 26, and the impeller 41 discharges cooling water. In the step S5, the air inlet passage 31 and discharge passage 29 are closed. In the step S6, the atmosphere opening passage 33 is in communication, and the back pressure control valve 27 is opened, so the interior of the cooling water tank 25 is at atmospheric pressure. The cooling water discharged from the pump 26 flows into the cooling water passage 16 of the fuel cell stack 2 via the recirculation passage 28. Subsequently, the cooling water discharged from the cooling water passage 16 is returned to the cooling water tank 25 via the recirculation passage 28 and the back pressure control valve 27. The pressure of the cooling water in the water passage 16 is controlled by opening adjustment of the back pressure control valve 27 by the controller 6.

In this way, when the fuel cell system is started up, by introducing an air pressure to the cooling water tank 25, a differential pressure is generated between the cooling water tank 25 and the discharge port of the pump 26. The air in the pump chamber 38 is discharged downstream of the pump chamber 38 by the cooling water introduced to the pump chamber 38 regardless of the inclination of the vehicle. As a result, the pump starts rapidly. The compressor 20 which introduces the air supplied to the oxygen electrode of the fuel cell stack 2, introduces air to the cooling water tank 25, so the fuel cell system has a simple construction.

In the aforesaid embodiment, the discharge port 39 of the pump 26 included in a water supply device was situated lower than the intake port 37. However, as long as one of the intake port 37 and discharge port 39 is situated in the bottom portion of the pump chamber 38 which has a substantially cylindrical shape, water in the pump chamber 38 can be discharged when the pump 26 has stopped. Also, in the aforesaid embodiment, the drive axis of the pump 26 used in the water supply device was horizontal, but the drive axis may be oriented in a vertical direction.

The entire contents of Japanese Patent Application P2003-347073(filed Oct. 6, 2003) are incorporated herein by reference.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

1. A water supply device which performs humidification and/or cooling of a fuel cell stack, comprising:
a water tank for storing water;
a pump which sends water from the water tank to the fuel cell stack, wherein one of a discharge port and intake port of the pump is situated in the bottom portion of a pump chamber;
a recirculation passage which recirculates water between the water tank and the fuel cell stack, wherein water leaves the water tank and flows through the pump and fuel cell stack to return to the water tank;
a compressor which functions to supply water stored in the water tank to the pump by supplying air to the water tank; and
a controller programmed to:
command the compressor to supply air to the water tank so as to start an operation of the water supply device, and subsequently command the pump to start.

2. The water supply device as defined in claim 1, wherein the discharge port of the pump is situated at a lower position than the intake port of the pump.

3. The water supply device as defined in claim 1, wherein the compressor further functions to supply air to an oxygen electrode of the fuel cell stack.

4. The water supply device as defined in claim 1, comprising a discharge passage connected to the atmosphere which branches off from the recirculation passage downstream of the pump, and a valve installed in the discharge passage,
wherein the controller is further programmed to control the valve to open the discharge port of the pump to atmosphere pressure so as to start the operation of the water supply device.

5. The water supply device as defined in claim 1, wherein the controller is further programmed to:
set an operating time of the compressor based on the differential pressure between the air pressure introduced to the water tank and the pressure of the pump discharge port, and based on the total volume of the recirculation passage from the water tank to the pump and the pump chamber.

6. The water supply device as defined in claim 1, wherein the positions of the pump and the fuel cell stack are higher than the position of the water tank.

7. A water supply device which performs humidification and/or cooling of a fuel cell stack, comprising:
a water tank for storing water;
a pump which sends water from the water tank to the fuel cell stack, wherein one of a discharge port and intake port of the pump is situated in the bottom portion of a pump chamber;
a recirculation passage which recirculates water between the water tank and the fuel cell stack, wherein water leaves the water tank and flows through the pump and fuel cell stack to return to the water tank;
a compressor which functions to supply water stored in the water tank to the pump by supplying air to the water tank; and
means for commanding the compressor to supply air to the water tank so as to start an operation of the water supply device, and subsequently commanding the pump to start.

8. A start method for starting a water supply device which performs humidification and/or cooling of a fuel cell stack, the water supply device having: a water tank for storing water; a pump which sends water from the water tank to the fuel cell stack, wherein one of a discharge port and intake port of the pump is situated in the bottom portion of a pump chamber; a recirculation passage which recirculates water between the water tank and the fuel cell stack, wherein water leaves the water tank and flows through the pump and fuel cell stack to return to the water tank; and a compressor which functions to supply water stored in the water tank to the pump by supplying air to the water tank;
the start method comprising:
commanding the compressor to supply air to the water tank whereby water stored in the water tank is supplied to the pump, and subsequently commanding the pump to start.
